(19) United States
(12) Patent Application Publication
(10) Pub. No.: US 2026/0059422 A1
(43) Pub. Date: Feb. 26, 2026

(54) LOW-ENERGY ROUTING METHOD BASED ON INTER-SATELLITE COMMUNICATION

(71) Applicant: CHONGQING UNIVERSITY OF POSTS AND TELECOMMUNICATIONS, Chongqing (CN)

(72) Inventors: Chang Su, Chongqing (CN); Xianzhong XIE, Chongqing (CN); Shihan WANG, Chongqing (CN)

(21) Appl. No.: 18/037,557

(22) PCT Filed: Jun. 30, 2022
(86) PCT No.: PCT/CN2022/102598

§ 371 Date: May 14, 2025

(30) Foreign Application Priority Data
Jul. 5, 2021 (CN) 202110755984.4

(51) Int. Cl. H04W 40/10; H04B 7/185; H04L 45/12

(52) U.S. Cl. CPC H04W 40/10; H04B 7/18521; H04L 45/12

(57) ABSTRACT

The invention relates to a low-energy-consumption routing method based on inter-satellite communication which belongs to the technical field of communication. The method comprises calculating of improved three-dimensional Fermat points, calculating of Fermat points of three target regions, selecting of satellite nodes of Fermat points and low-energy-consumption Fermat point three-dimensional routing algorithm LEFTR. The invention improves the calculation method of the three-dimensional Fermat point to make it more suitable for inter-satellite communication; a direct calculation method of Fermat points of three target regions in a three-dimensional environment is provided; a node searching algorithm of Fermat point is provided, which is used for searching nodes serving as transfer transmission; the algorithm enables the energy consumption of network transmission to be more balanced when a transfer transmission node needs to be found after the Fermat point is calculated; an efficient regional multicast algorithm LEFTR suitable for satellite communication is provided; the algorithm is extended to a multi-target region, and a Fermat point tree is constructed by using the characteristics of Fermat points, so that low-energy-consumption data transmission of the multi-target region is realized.

### TECHNICAL FIELD

The invention belongs to the technical field of communication and relates to a low-energy-consumption routing method based on inter-satellite communication.

### BACKGROUND

Although the Internet of Things based on traditional terrestrial cellular networks has matured, sensors in areas such as deep rift valleys or buoys on the sea are not within the coverage of terrestrial cellular networks, so they cannot connect to the Internet. Satellite sensor networks, especially low-orbit satellites, can be used as a supplement to the coverage of the Internet in non-cellular coverage areas because they are easy to achieve long-distance communication as a new direction for the development of the Internet of Things.

However, the direct communication between low-orbit satellites, especially the inter-satellite communication for regional multicasting, often consumes a lot of energy, and the satellite energy is limited, so it is particularly important to have a low-energy routing suitable for inter-satellite communication.

### Invention Content

In view of this, the object of the present invention is to provide a low-energy-consumption routing method based on inter-satellite communication.

To achieve the above purpose, the present invention provides the following technical solution:

A low-energy-consumption routing method based on inter-satellite communication, wherein the method includes calculating of improved three-dimensional Fermat points, calculating of Fermat points of three target regions, selecting of satellite nodes of Fermat points and low-energy-consumption Fermat point three-dimensional routing algorithm LEFTR.

Further, the calculating of improved three-dimensional Fermat points is:
set side length of cube as x;
Condition 1: in the cube, points A and B are two vertices of the cube, line AB is diagonal of the cube, and C is any point in the cube that is different from points A and B. At this time, point C is Fermat point F;

$$FA + FB + FC = FA + FB = 2 \sqrt{{x}^{2} + {( \frac{1}{2} x )}^{2}} = \sqrt{5} x \qquad ( 1.1 )$$

when the points A and B are two vertices of the cube, line AB is diagonal of the cube, C is any point in the cube that is different from the points A and B, and FA+FB+FC is the shortest, point C is the Fermat point;
Condition 2: in the cube, points A, B, and C are three vertices of the cube, and sides AB, BC, and CA are diagonals of faces. At this time, Fermat point F is the center point of the cube;

$$FA + FB + FC = 3 \sqrt{{( \frac{1}{2} x )}^{2} + {( \sqrt{{( \frac{1}{2} x )}^{2} + {( \frac{1}{2} x )}^{2}} )}^{2}} ≦ 3 x ⇒ \frac{9}{4} x ≦ 3 x \qquad ( 1.2 )$$

wherein 3x is the value of FA+FB+FC when the Fermat point is the vertex P of the cube corresponding to ΔABC. When the points A, B, and C are three vertices of the cube, sides AB, BC, and CA are diagonals of faces, and FA+FB+FC is the shortest, the Fermat point is the center point of the cube;
Condition 3: in the cube, points A and B are two vertices of the cube, AB is a side of the cube, point C is a point on the opposite side parallel to side AB. At this time, Fermat point F is the center point of the cube;

$$FA + FB + FC = 2 \sqrt{{( \frac{1}{2} x )}^{2} + {( \sqrt{{( \frac{1}{2} x )}^{2} + {( \frac{1}{2} x )}^{2}} )}^{2}} + \frac{1}{2} \sqrt{{x}^{2} + ( \sqrt{{x}^{2} + {x}^{2}} )} ≦ x + \sqrt{2} x ⇒ 2 \sqrt{\frac{1}{4} {x}^{2} + \frac{1}{2} {x}^{2}} + \frac{1}{2} \sqrt{3 {x}^{2}} ≦ x + \sqrt{2} x ⇒ \frac{3 \sqrt{3}}{2} x ≦ ( 1 + \sqrt{2} ) x \qquad ( 1.3 )$$

wherein x+\sqrt{2x} is the value of FA+FB+FC when taking point P from the Fermat point. In the proof, distance from the vertex of the cube to the center point is taken and the distance from any other point on the opposite side to the center point is smaller than this distance. When the points A and B are two vertices of the cube, AB is a side of the cube, point C is a point on the opposite side parallel to side AB, the Fermat point is the center point of the cube.

Further, the calculating of Fermat points of three target regions is:
set side length of cube as x;

Condition 1: in the cube, points A and B are two vertices of the cube, line AB is diagonal of the cube, wherein point D is divided into two cases. In the two cases, the points D is divided into D₁ and D₂ respectively;
when line connections of the four points A, B, C and D intersects, as D₁ shown in figure, Fermat point is taken as the intersection point F₁, and the proof is as follows:

$$( 1.4 )$$

$${F}_{1} A + {F}_{1} B + {F}_{1} C = \sqrt{{x}^{2} + {( \sqrt{{x}^{2} + {x}^{2}} )}^{2}} + \sqrt{{( \frac{1}{2} x )}^{2} + ( \sqrt{{x}^{2} + {( \frac{1}{2} x )}^{2}} )} = \frac{3 \sqrt{3}}{2} x \leq \sqrt{{x}^{2} + {( \sqrt{{x}^{2} + {x}^{2}} )}^{2}} + \frac{\sqrt{{x}^{2} + {x}^{2}}}{2} + \frac{\sqrt{{x}^{2} + {x}^{2}}}{2} = ( \sqrt{2} + \sqrt{3} ) x$$

wherein (\sqrt{2}+\sqrt{3})x is the length of FA+FB+FC when the Fermat point is taken as the center point of the cube. When there is an intersection point between the four points A, B, C and D, and the Fermat point as the intersection point F₁ is taken to have the shortest length of FA+FB+FC, the Fermat point is taken as the intersection point F₁;
when line connections of the four points A, B, C and D don't intersects, Fermat point is taken as the center point of the cube, and the proof is as follows:

$${F}_{2} A + {F}_{2} B + {F}_{2} C = \sqrt{{x}^{2} + {x}^{2}} + \sqrt{{x}^{2} + {( {x}^{2} + {x}^{2} )}^{2}} = ( \sqrt{2} + \sqrt{3} ) x \leq x + 2 \sqrt{{( \frac{1}{2} x )}^{2} + {x}^{2}} = ( 1 + \sqrt{5} ) x \qquad ( 1.5 )$$

wherein (1+\sqrt{5})x is the length of FA+FB+FC when the Fermat point is taken as point D₂. When the line connections of the four points A, B, C and D don't intersects, and the Fermat point as the center point of the cube is taken to have the shortest length of FA+FB+FC, the Fermat point is taken as the center point of the cube;
Condition 2: in a cube, lines AB, BC, and CA are diagonals of faces, wherein point D is divided into two cases. In the two cases, the point D is divided into D₁ and D₂ respectively; under this condition, the line connections of the four points A, B, C and D don't intersects, D₁ is located above ΔABC, and D₂ is located below Δ ABC;
(1) when point D is located above ΔABC, the Fermat point is taken as the center point of the cube, and the proof is as follows:

$$( 1.6 )$$

$${F}_{1} A + {F}_{1} B + {F}_{1} C = 2 \sqrt{{x}^{2} + {( \sqrt{{x}^{2} + {x}^{2}} )}^{2}} = 2 \sqrt{3} x \leq 3 \sqrt{{x}^{2} + {x}^{2}} = 3 \sqrt{2} x$$

wherein 3\sqrt{2}x is the length of FA+FB+FC when the Fermat point is taken as D₁. When D is located above ΔABC, and the Fermat point as the center point of the cube is taken to have the shortest length of FA+FB+FC, the Fermat point is taken as the center point of the cube;
(2) when point D is located below ΔABC, the Fermat point is taken as D₂, and the proof is as follows:

$${F}_{2} A + {F}_{2} B + {F}_{2} C = x + x + x = 3 x \leq 2 \sqrt{{x}^{2} + {( \sqrt{{x}^{2} + {x}^{2}} )}^{2}} = 2 \sqrt{3} x \qquad ( 1.7 )$$

wherein 3\sqrt{2}x is the length of FA+FB+FC when the Fermat point is taken as the center point of the cube. When D is located below ΔABC, and the Fermat point as the point D₂ is taken to have the shortest length of FA+FB+FC, the Fermat point is taken as the point D₂;
Condition 3: in the cube, line AB is a side of the cube, and point D is divided into two cases. In the two cases, the point D is divided into D₁ and D₂ respectively; there is intersection point at the position A, B, C and D of D₁, but there is no intersection point at the position A, B, C and D of D₂;
when line connections of the four points A, B, C and D intersects, Fermat point is taken as intersection point F₁, and the proof is as follows:

$${F}_{1} A + {F}_{1} B + {F}_{1} C = 2 \sqrt{{x}^{2} + {( \sqrt{{x}^{2} + {( \frac{1}{2} x )}^{2}} )}^{2}} = 3 x \leq \frac{1}{2} \sqrt{{x}^{2} + {x}^{2}} \times 2 + \frac{1}{2} \sqrt{{x}^{2} + {( \sqrt{{x}^{2} + {x}^{2}} )}^{2}} \times 2 = ( \sqrt{2} + \sqrt{3} ) x \qquad ( 1.8 )$$

wherein (\sqrt{2}+\sqrt{3})x is the length of FA+FB+FC when the Fermat point is taken as the center point of the cube. When the line connections of the four points A, B, C and D intersects, and the Fermat point as the center point of the cube is taken to have the shortest length of FA+FB+FC, the Fermat point is taken as the center point of the cube;
when line connections of the four points A, B, C and D don't intersects, Fermat point is taken as the center point of the cube, and the proof is as follows:

$$( 1.9 )$$

$${F}_{2} A + {F}_{2} B + {F}_{2} C = \sqrt{{x}^{2} + {x}^{2}} + \sqrt{{x}^{2} + {( \sqrt{{x}^{2} + {x}^{2}} )}^{2}} = ( \sqrt{2} + \sqrt{3} ) x \leq \sqrt{{( \frac{1}{2} x )}^{2} + {( \frac{1}{2} x )}^{2}} + \sqrt{{x}^{2} + {( \frac{1}{2} x )}^{2}} + \sqrt{{x}^{2} + {( \sqrt{{x}^{2} + {( \frac{1}{2} x )}^{2}} )}^{2}} = \frac{\sqrt{2} + \sqrt{5} + 3}{2} x$$

wherein

$$\frac{\sqrt{2} + \sqrt{5} + 3}{2} x$$

is the length of FA+FB+FC when the Fermat point is taken as point D₂. When the line connections of the four points A, B, C and D don't intersects, and the Fermat point as the center point of the cube is taken to have the shortest length of FA+FB+FC, the Fermat point is taken as the center point of the cube.

Further, the selecting of satellite nodes of Fermat points is:
satellite node i has two important parameters: remaining energy Eᵢ and the distance D_{if} to the Fermat point; distance between the node and the Fermat point is considered to avoid excessive energy consumption of a certain node; when remaining energy of sensor node is lower than threshold T, the Fermat point node is changed, and the threshold T takes 30% of total energy of the node; after calculating the position of the Fermat point, the position of the Fermat point is taken as the center of the circle to search outward, wherein the search range is a sphere, and the radius r starts from 0 and increments by 1 km; if there is a node in first search range, the closest node to the Fermat point is selected, otherwise search continues; if there are nodes with same distance in same search range, one of them is randomly selected; if energy of the selected node is less than the threshold, search continues.

Further, the low-energy-consumption Fermat point three-dimensional routing algorithm LEFTR is:
S21: related definitions and symbols
the physical topology of the network is represented by M=(N, L. G), wherein N represents the node set, L represents the path set, and G=(P, Q) represents the region set, P represents the node set in the region; the node in the region is P, Q represents the path in the region, and the number of nodes in the network is |N|, the number of paths is |L|, and the number of nodes in the region is |P|; the path between nodes x and y is composed of a set of finite sequences τ={n₀ , n₁ , . . . , nₙ}, and the effective path (x,y) between x and y has a length of |τ|;
packet reception rate is defined as:

$$R ( τ ) = \frac{{\sum }_{0 \leq i \leq \vert P \vert} \vert {p}_{i} \vert}{\vert P \vert} , p ∈ P , \vert {p}_{i} \vert = 1 \qquad ( 2.1 )$$

packet repetition rate is defined as:

$$M ( τ ) = \frac{{\sum }_{0 \leq i \leq \vert O \vert} \vert {n}_{i} \vert}{\vert O \vert} , n ∈ N , \vert {n}_{i} \vert = 1 \qquad ( 2.2 )$$

wherein n is the node that received duplicate packet, |O|=50;
S22: two target regions algorithm
source point sends data to the Fermat point, and then the Fermat point forwards the data to two target regions; the transmission from the source point to the Fermat point and from the Fermat point to the two target regions adopts greedy forwarding, and the data is flooded in the target region; the two target regions are region 1 and region 2;
S221: a triangle is formed by the source point, center point of region 1 and center point of region 2, and position of the Fermat point of this triangle is calculated;
S222: node search algorithm is applied to find node which can be used as Fermat point;
S223: the source node sends the data to the Fermat point node, and then the Fermat point node forwards the data to any node in the two regions; the forwarding of these two parts adopts greedy forwarding; when any point in the region receives the data, flooding method is used in this region to forward the data, so that all nodes in the two regions can receive the data to complete the regional multicast in the two regions;
S23: multi-target regions algorithm
S231: multi-target regions algorithm
the source point forms first triangle with region 1 and region 2, first Fermat point 1 is calculated, and Fermat point node selection algorithm is used to calculate first Fermat point node 1; then, the source point, the Fermat point 1 and region 3 form second triangle, second Fermat point 2 is calculated, and the Fermat point node selection algorithm is used to calculate second Fermat point node 2; the Fermat point 1 and the Fermat point 2 are connected to form Fermat point tree; if the source point wants to send data to three regions, the source point first send the data to Fermat point node 2 and then continue to send the data to Fermat point node 1, two Fermat points send the data to their corresponding regions; the transmission from the source point to the Fermat point and from the Fermat point to the region adopts greedy forwarding, and the data is flooded in the target region;
S232: LEFTR algorithm for multi-target regions
a three-dimensional efficient transmission path is obtained by using the Fermat points, which is called a Fermat point tree; the cube represents three-dimensional network environment, the sphere represents the regional multicast region, virtual circle in the sphere represents satellite nodes, and region 1, region 2 and region 3 are three target regions respectively; regional multicasting in three regions is implemented;
S2321: the source point, the center point of region 1 and the center point of region 2 are connected to obtain a triangle, and the Fermat point 1 of this triangle is calculated;
S2322: the node search method is used to find a suitable node as a Fermat point which is called Fermat point node 1;
S2323: the source point, the Fermat point 1 and the center point of region 3 are connected to form a second triangle, the Fermat point of this triangle is calculated, and the Fermat point 2 is obtained;
S2324: the node search method is used to find a suitable node as a Fermat point which is called Fermat point node 2;
S2325: the Fermat point node 1 and the Fermat point node 2 are connected; the path from the source point to the Fermat point node 1 and then to the Fermat point node 2 is the shortest path for regional multicast in region 1, region 2 and region 3;
the connected nodes are the Fermat point node 1 and the Fermat point node 2; the source node sends data to the Fermat point node 1 and then forwards it to the Fermat point node 2, where forwarding of this part uses greedy forwarding; the Fermat point node 1 greedily forwards the data to region 1 and region 2 after receiving the data, any node in region 1 and region 2 floods their region with the received data, the Fermat point node 2 also greedily forwards the data to region 3 after receiving the data, any node in region 3 floods its area after receiving the data; when there are more regions, the source point, the Fermat point and center point of region are connected, the Fermat point of the formed triangle is calculated, and then the Fermat points are concatenated into the Fermat point tree.

### The Beneficial Effects of the Present Invention are:

1. The calculation method of Fermat point suitable for satellite network is explored and given; (1) the calculation method of three-dimensional Fermat points is improved to make it more suitable for inter-satellite communication; (2) a direct calculation method of Fermat points in three target regions in a three-dimensional environment is proposed, that is, the calculation method of Fermat points of four vertices complements the deficiency that the Fermat point cannot be found by three points in the three-dimensional environment.

2. A Fermat point node searching algorithm is proposed to find nodes which act as transit transmissions. This algorithm is used to make the energy consumption of network transmission more balanced when it is necessary to find a transit transmission node after calculating the Fermat point.

3. An efficient regional multicast algorithm LEFTR suitable for satellite communication is proposed. (1) The regional multicast algorithm LEFTR for two target regions is proposed to realize low-energy-consumption data transmission in two target regions; (2) the algorithm is extended to multi-target regions, which uses the characteristics of Fermat points to constructs a Fermat point tree and realizes low-energy-consumption data transmission of multi-target regions.

Other advantages, objectives and features of the present invention will be illustrated in the following description to some extent, and will be apparent to those skilled in the art based on the following investigation and research to some extent, or can be taught from the practice of the present invention. The objectives and other advantages of the present invention can be realized and obtained through the following description.

### DESCRIPTION OF DRAWINGS

To enable the purpose, the technical solution and the advantages of the present invention to be more clear, the present invention will be preferably described in detail below in combination with the drawings, wherein:

FIG. 1 is a schematic diagram of the improvement of the three-dimensional Fermat point calculation; (a) is the Fermat point calculation condition 1; (b) is the Fermat point calculation condition 2; (c) is the Fermat point calculation condition 3;

FIG. 2 is a schematic diagram of the calculation of Fermat points in the three target regions; (a) is the calculation condition 1 of the three target Fermat points; (b) is the calculation condition 2 of the three target Fermat points; (c) is the calculation condition 3 of the three target Fermat points;

FIG. 3 is a schematic diagram of node selection;

FIG. 4 is a schematic diagram of a satellite network structure;

FIG. 5 is a schematic diagram of satellite network regional multicast;

FIG. 6 is the theory of two target regions;

FIG. 7 is the LEFTR of the two target regions;

FIG. 8 is the multi-target regions theory;

FIG. 9 is the LEFTR of the multi-target regions;

FIG. 10 shows the packet receiving rate; (a) is the packet receiving rate under the dense coverage of 500 nodes; (b) is the packet receiving rate under the non-dense coverage of 200 nodes;

FIG. 11 shows the packet repetition rate; (a) is the repetition rate of data packets received by nodes under non-dense coverage of 200 nodes; (b) is the repetition rate of data packets received by nodes under non-dense coverage of 500 nodes;

FIG. 12 shows the network crash time; (a) is the network crash time under the non-dense coverage of 200 nodes; (b) is the network crash time under the dense coverage of 500 nodes.

### DETAILED DESCRIPTION

Embodiments of the present invention are described below through specific embodiments. Those skilled in the art can understand other advantages and effects of the present invention easily through the disclosure of the description. The present invention can also be implemented or applied through additional different specific embodiments. All details in the description can be modified or changed based on different perspectives and applications without departing from the spirit of the present invention. It should be noted that the figures provided in the following embodiments only exemplarily explain the basic conception of the present invention, and if there is no conflict, the following embodiments and the features in the embodiments can be mutually combined.

Same or similar reference numerals in the drawings of the embodiments of the present invention refer to same or similar components. It should be understood in the description of the present invention that terms such as “upper”, “lower”, “left”, “right”, “front” and “back” indicate direction or position relationships shown based on the drawings, and are only intended to facilitate the description of the present invention and the simplification of the description rather than to indicate or imply that the indicated device or element must have a specific direction or constructed and operated in a specific direction, and therefore, the terms describing position relationships in the drawings are only used for exemplary description and shall not be understood as a limitation to the present invention; for those ordinary skilled in the art, the meanings of the above terms may be understood according to specific conditions.

1.1 Fermat Point Node Selection Algorithm Based on the concept and characteristics of the Fermat point and the calculation method of the three-dimensional Fermat point, the method for calculating the Fermat point in the three-dimensional environment is improved, and a method for directly calculating the Fermat point for three target regions is proposed, that is, in the three-dimensional environment, the Fermat points of the four vertices are calculated, and then a node selection algorithm is proposed. This algorithm is to select the node that acts as Fermat point and play the role of transfer transmission, thereby completing data transmission with low energy consumption.

### 1.2 Improvement of Three-Dimensional Fermat Point Calculation

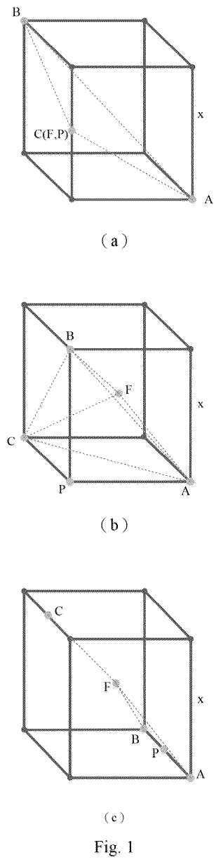

FIG. 1 is a schematic diagram of the improvement of the three-dimensional Fermat point calculation. The invention improves the calculation of the mentioned three-dimensional Fermat point, and proposes a method for finding the three-dimensional Fermat point based on a cube.
set side length of cube as x;
Condition 1: as shown in FIG. 1(a), in the cube, points A and B are two vertices of the cube, line AB is diagonal of the cube, and C is any point in the cube that is different from points A and B. At this time, point C is Fermat point F;

$$FA + FB + FC = FA + FB = 2 \sqrt{{x}^{2} + {( \frac{1}{2} x )}^{2}} = \sqrt{5} x \qquad ( 1.1 )$$

when the points A and B are two vertices of the cube, line AB is diagonal of the cube, C is any point in the cube that is different from the points A and 8, and FA+FB+FC is the shortest, point C is the Fermat point;
Condition 2: as shown in FIG. 1(b), in the cube, points A, B, and C are three vertices of the cube, and sides AB, BC, and CA are diagonals of faces. At this time, Fermat point F is the center point of the cube;

$$FA + FB + FC = 3 \sqrt{{( \frac{1}{2} x )}^{2} + {( \sqrt{{( \frac{1}{2} x )}^{2} + {( \frac{1}{2} x )}^{2}} )}^{2}} ≦ 3 x ⇒ \frac{9}{4} x ≦ 3 x \qquad ( 1.2 )$$

wherein 3x is the value of FA+FB+FC when the Fermat point is the vertex P of the cube corresponding to ΔABC. When the points A, B, and C are three vertices of the cube, sides AB, BC, and CA are diagonals of faces, and FA+FB+FC is the shortest, the Fermat point is the center point of the cube;
Condition 3: as shown in FIG. 1(c), in the cube, points A and B are two vertices of the cube, AB is a side of the cube, point C is a point on the opposite side parallel to side AB. At this time, Fermat point F is the center point of the cube;

$$( 1.3 )$$

$$FA + FB + FC = 2 \sqrt{{( \frac{1}{2} x )}^{2} + {( \sqrt{{( \frac{1}{2} x )}^{2} + {( \frac{1}{2} x )}^{2}} )}^{2}} + \frac{1}{2} \sqrt{{x}^{2} + ( \sqrt{{x}^{2} + {x}^{2}} )} ≦ x + \sqrt{2} x ⇒ 2 \sqrt{\frac{1}{4} {x}^{2} + \frac{1}{2} {x}^{2}} + \frac{1}{2} \sqrt{3 {x}^{2}} ≦ x + \sqrt{2} x ⇒ \frac{3 \sqrt{3}}{2} x ≦ ( 1 + \sqrt{2} ) x$$

wherein x+\sqrt{2x} is the value of FA+FB+FC when taking point P from the Fermat point. In the proof, distance from the vertex of the cube to the center point is taken and the distance from any other point on the opposite side to the center point is smaller than this distance. When the points A and B are two vertices of the cube, AB is a side of the cube, point C is a point on the opposite side parallel to side AB, the Fermat point is the center point of the cube.

### 1.3 Calculation of Fermat Points in the Three Target Regions

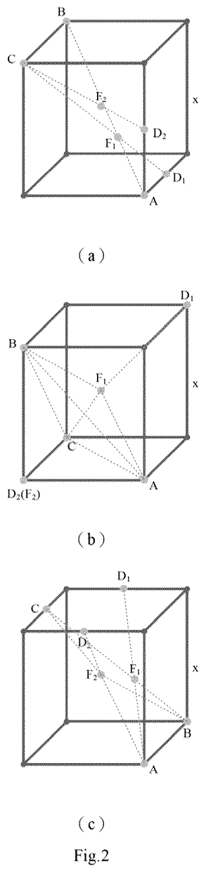

FIG. 2 is a schematic diagram of the calculation of Fermat points in the three target regions. This section gives the method of using a cube to calculate the Fermat point of the three target regions, that is, in the three-dimensional environment, the Fermat point of the four vertices is calculated, because there is no given algorithm for calculating the Fermat point of the four vertices, so this section just gives a point that is relatively more consistent with the concept of Fermat point.
set side length of cube as x;
Condition 1: as shown in FIG. 2(a), in the cube, points A and B are two vertices of the cube, line AB is diagonal of the cube, wherein point D is divided into two cases. In the two cases, the points D is divided into D₁ and D₂ respectively;
when line connections of the four points A, B, C and D intersects, as D₁ shown in figure, Fermat point is taken as the intersection point F₁, and the proof is as follows:

$$( 1.4 )$$

$${F}_{1} A + {F}_{1} B + {F}_{1} C = \sqrt{{x}^{2} + {( \sqrt{{x}^{2} + {x}^{2}} )}^{2}} + \sqrt{{( \frac{1}{2} x )}^{2} + ( \sqrt{{x}^{2} + {( \frac{1}{2} x )}^{2}} )} = \frac{3 \sqrt{3}}{2} x ≦ \sqrt{{x}^{2} + {( \sqrt{{x}^{2} + {x}^{2}} )}^{2}} + \frac{\sqrt{{x}^{2} + {x}^{2}}}{2} + \frac{\sqrt{{x}^{2} + {x}^{2}}}{2} = ( \sqrt{2} + \sqrt{3} ) x$$

wherein (\sqrt{2}+\sqrt{3})x is the length of FA+FB+FC when the Fermat point is taken as the center point of the cube. When there is an intersection point between the four points A, B, C and D, and the Fermat point as the intersection point F₁ is taken to have the shortest length of FA+FB+FC, the Fermat point is taken as the intersection point F₁;
when line connections of the four points A, B, C and D don't intersects, Fermat point is taken as the center point of the cube, and the proof is as follows:

$${F}_{2} A + {F}_{2} B + {F}_{2} C = \sqrt{{x}^{2} + {x}^{2}} + \sqrt{{x}^{2} + {( \sqrt{{x}^{2} + {x}^{2}} )}^{2}} = ( \sqrt{2} + \sqrt{3} ) x ≦ 2 \sqrt{{( \frac{1}{2} x )}^{2} + {x}^{2}} = ( 1 + \sqrt{5} ) x \qquad ( 1.5 )$$

wherein (1+\sqrt{5})x is the length of FA+FB+FC when the Fermat point is taken as point D₂. When the line connections of the four points A, B, C and D don't intersects, and the Fermat point as the center point of the cube is taken to have the shortest length of FA+FB+FC, the Fermat point is taken as the center point of the cube;
Condition 2: as shown in FIG. 2(b), in a cube, lines AB, BC, and CA are diagonals of faces, wherein point D is divided into two cases. In the two cases, the point D is divided into D₁ and D₂ respectively; under this condition, the line connections of the four points A, B, C and D don't intersects, D₁ is located above ΔABC, and D₂ is located below ΔABC;
(1) when point D is located above ΔABC, the Fermat point is taken as the center point of the cube, and the proof is as follows:

$$( 1.6 )$$

$${F}_{1} A + {F}_{1} B + {F}_{1} C = 2 \sqrt{{x}^{2} + {( \sqrt{{x}^{2} + {x}^{2}} )}^{2}} = 2 \sqrt{3} x ≦ 3 \sqrt{{x}^{2} + {x}^{2}} = 3 \sqrt{2} x$$

wherein 3\sqrt{2}x is the length of FA+FB+FC when the Fermat point is taken as D₁. When D is located above ΔABC, and the Fermat point as the center point of the cube is taken to have the shortest length of FA+FB+FC, the Fermat point is taken as the center point of the cube;
(2) when point D is located below ΔABC, the Fermat point is taken as D₂, and the proof is as follows:

$${F}_{2} A + {F}_{2} B + {F}_{2} C = x + x + x = 3 x \leq 2 \sqrt{{x}^{2} + {( \sqrt{{x}^{2} + {x}^{2}} )}^{2}} = 2 \sqrt{3} x \qquad ( 1.7 )$$

wherein 2\sqrt{3x} is the length of FA+FB+FC when the Fermat point is taken as the center point of the cube. When D is located below ΔABC, and the Fermat point as the point D₂ is taken to have the shortest length of FA+FB+FC, the Fermat point is taken as the point D₂;
Condition 3: as shown in FIG. 2(c), in the cube, line AB is a side of the cube, and point D is divided into two cases. In the two cases, the point D is divided into D₁ and D₂ respectively; there is intersection point at the position A, B, C and D of D₁, but there is no intersection point at the position A, B, C and D of D₂;
when line connections of the four points A, B, C and D intersects, Fermat point is taken as intersection point F₁, and the proof is as follows:

$${F}_{1} A + {F}_{1} B + {F}_{1} C = 2 \sqrt{{x}^{2} + {( \sqrt{{{x}^{2} ( \frac{1}{2} x )}^{2}} )}^{2}} = 3 x \leq \frac{1}{2} \sqrt{{x}^{2} + {x}^{2}} \times 2 + \frac{1}{2} \sqrt{{x}^{2} + {( \sqrt{{x}^{2} + {x}^{2}} )}^{2}} \times 2 = ( \sqrt{2} + \sqrt{3} ) x \qquad ( 1.8 )$$

wherein (\sqrt{2}+\sqrt{3})x is the length of FA+FB+FC when the Fermat point is taken as the center point of the cube. When the line connections of the four points A, B, C and D intersects, and the Fermat point as the center point of the cube is taken to have the shortest length of FA+FB+FC, the Fermat point is taken as the center point of the cube;
when line connections of the four points A, B, C and D don't intersects, Fermat point is taken as the center point of the cube, and the proof is as follows:

$${F}_{2} A + {F}_{2} B + {F}_{2} C = \sqrt{{x}^{2} + {x}^{2}} + \sqrt{{x}^{2} + {( \sqrt{{x}^{2} + {x}^{2}} )}^{2}} = ( \sqrt{2} + \sqrt{3} ) x \leq \sqrt{{( \frac{1}{2} x )}^{2} + {( \frac{1}{2} x )}^{2}} + \sqrt{{x}^{2} + {( \frac{1}{2} x )}^{2}} + \sqrt{{x}^{2} + {( \sqrt{{{x}^{2} ( \frac{1}{2} x )}^{2}} )}^{2}} = \frac{\sqrt{2} + \sqrt{5} + 3}{2} x \qquad ( 1.9 )$$

wherein

$$\frac{\sqrt{2} + \sqrt{5} + 3}{2} x$$

is the length of FA+FB+FC when the Fermat point is taken as point D₂. When the line connections of the four points A, B, C and D don't intersects, and the Fermat point as the center point of the cube is taken to have the shortest length of FA+FB+FC, the Fermat point is taken as the center point of the cube.

### 1.4 Fermat Point Satellite Node Selection Algorithm

One of the vertices of the triangle is regarded as the source point, and the remaining two vertices are regarded as two target regions, then the position of the Fermat point of the triangle can be obtained through calculation; this node is selected as the Fermat point to obtain a shortest path from the source point to two target regions, and the Fermat point is the intermediate forwarding node of this path. However, there is a problem that the Fermat point calculated by mathematical method is a very precise position, so there may not be exactly one satellite node at the calculated Fermat point, so how to select a node as the Fermat point satellite node is crucial. The node selected as Fermat point is called Fermat point node.

The Fermat point node is a very important node, responsible for the central transmission of data. To reach the data in the corresponding region, it needs to pass through the Fermat point node. Therefore, the communication volume of the Fermat point node is much higher than that of ordinary nodes, and the energy consumption of the Fermat point node will also be higher than that of the ordinary node, but the life of the satellite is limited. In order to avoid premature consumption of the life of the satellite node, this invention comprehensively considers the following two points: the distance between the satellite node and the actual Fermat point, and the satellite's remaining life. After calculating the Fermat point, look for satellite nodes from around the Fermat point, and select the satellite with the most remaining power as the Fermat point node while ensuring that the Fermat point node is as close as possible to the Fermat point.

### 1.4.1 Node Selection Method

satellite node i has two important parameters: remaining energy Eᵢ and the distance Dg to the Fermat point; distance between the node and the Fermat point is considered to avoid excessive energy consumption of a certain node; when remaining energy of sensor node is lower than threshold T, the Fermat point node is changed, and the threshold T takes 30% of total energy of the node; after calculating the position of the Fermat point, the position of the Fermat point is taken as the center of the circle to search outward, wherein the search range is a sphere, and the radius r starts from 0 and increments by 1 km; if there is a node in first search range, the closest node to the Fermat point is selected, otherwise search continues; if there are nodes with same distance in same search range, one of them is randomly selected; if energy of the selected node is less than the threshold, search continues.

### 1.4.2 Algorithm Implementation

This section uses pseudocode to show the selection algorithm of Fermat point nodes, as shown in Table 1.1.

TABLE 1.1
Fermat point node selection
Algorithm : Fermat point node selection

Definition: Eᵢ represents the remaining energy of satellite node i; the threshold of

satellite node energy is set to T; D_{if} is the distance from node i to Fermat point f; l
represents the searched node set; r represents the outward search radius, r = 1; Fermat
point node fn.

| 1) | loop | | |
|---|---|---|---|
| 2) | | if no node is found in the region with radius r | |
| 3) | | | increase the search radius r=r+1; |
| 4) | | if a node is found; | |
| 5) | | | jump out; |

| 6) | L → ∞ ; | |
|---|---|---|
| 7) | loop | |
| 8) | | search for satellite node i that has not been searched in the region with a |

radius of r;

| | |
|---|---|
| 9) | if the energy of node i is higher than the threshold T, Eᵢ ≥ T |
| 10) | add node i to set l; |
| 11) | calculate the distance D_{if} between the current node i and Fermat point f; |
| 12) | if the distance D_{if} is lower than L, D_{if} ≤ L |
| 13) | update the shortest distance L = D_{if}, fn = i; |

| | |
|---|---|
| 14) | return the Fermat point node fn; |

### 1.5 Application of Fermat Point on Satellite Node

The previous section gave the selection algorithm of the Fermat point node, and then how to combine the Fermat point with the satellite node is the problem to be considered in this section.

### 1.5.1 Satellite Network Structure

Formation flights, constellations and constellations belong to the parallel relationship and belong to the distributed satellite system. Each satellite in the formation flight operates in its own corresponding orbit, and it needs to join the inter-satellite closed-circuit orbit to ensure that the flying satellites maintain formation. The constellation increases its coverage area, and the orbital position of a single satellite is adjusted periodically through the ground station to maintain the satellite orbit. The constellation is the simplest form of satellite distribution, mainly used to observe the monitoring of space environment parameters.

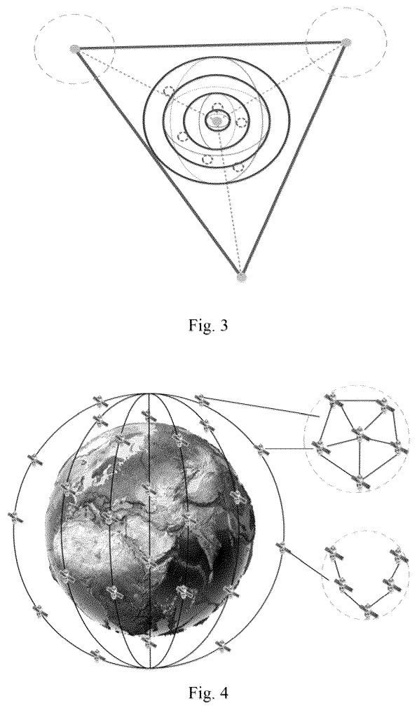

However, the three satellite systems described above are relatively dispersed in their system implementation, and they are not connected to each other. This communication method is not conducive to maximizing the efficiency of the satellite network under the current trend of diversification of aerospace services. At present, a low-orbit satellite network capable of self-organizing networks has emerged, that is, interstellar link communication. As shown in FIG. 4, this satellite network is similar to a wireless sensor network, and can connect such as formation flights, constellations and constellations. The satellite can sense the existence of adjacent satellite nodes, automatically establish inter-satellite links, and have functions such as dynamic routing, which avoids data being sent back to the ground for processing and routing selection, reduces secondary mission assignments and communication delay, so as to meet the current personalized network requirements. The invention studies the routing algorithm based on this kind of LEO satellite network.

### 1.5.2 Combination of Fermat Points and Satellite Nodes

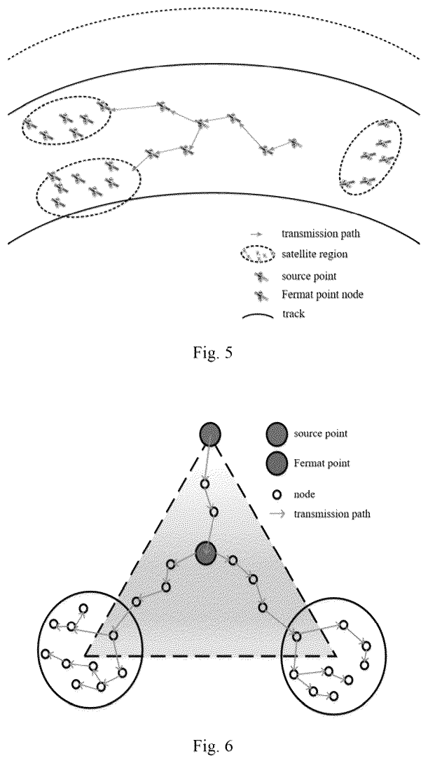

Based on self-organized low-orbit satellite network (interstellar link communication), assuming a satellite as the source point (this source point is the satellite corresponding to the earth region to send data), this source point wants to send data to two specific satellite regions, these two satellite regions are the target regions. First, the source node sends the data to the Fermat point node calculated in the previous section, and then the Fermat point node sends the data to the two target regions. Based on self-organization of satellite and function of position sensing, the path from the source point to the Fermat point and the path from the Fermat point to the two target regions both use greedy forwarding. When the data reaches the target region, it will be flooded in the region, so that all satellite nodes receive the target data and then send the data to the ground area as shown in FIG. 5.

### 1.6 Summary of This Section

The work in this section mainly focuses on the Fermat point calculation and the Fermat point node selection algorithm. Firstly, the method for calculating the Fermat point suitable for the satellite environment is given. If it is difficult to calculate the Fermat point of the three vertices, that calculation of the four vertices can be used, which ensures the success rate of Fermat point calculation. Then the selection algorithm of Fermat point nodes is given to select satellites that can play the role of transit transmission. These two methods are realized by the LEFTR algorithm.

### 2 LEFTR Algorithm

Based on the Fermat point calculation method and the Fermat point node selection algorithm, this section will introduce the low-energy-consumption Fermat point three-dimensional routing algorithm LEFTR in detail. What this algorithm does is to send data from the source point to all nodes in the specified region, and the source point only sends it once. This section is divided into four parts, the first part introduces the related definitions and symbols, the second part focuses on two target regions which first explains the theoretical part in a flat environment and then introduces the working principle of LEFTR in a complex environment, the third part is aimed at multiple target regions where the theoretical part is also explained first and then the multi-target regions LEFTR algorithm is introduced, and the fourth part is simulation where the experimental results are analyzed in detail.

The Fermat point refers to the point in a triangle where the sum of the distances to the three vertices is the shortest. That is, in ΔABC, a path, which starts from vertex A to vertex B and vertex C, passing through the Fermat point should be shortest path. If vertex A is regarded as the source point, and vertex B and vertex C are regarded as two regions respectively, the source point will send the same data to region B and region C; the data sent by the source point can be forwarded to the Fermat point first then forward them to region B and region C respectively from the Fermat point. Such a forwarding path is theoretically the shortest. Shortening the transmission path can reduce the number of intermediate hops, thereby saving node energy and reducing delay.

### 2.1 Related Definitions and Symbols

the physical topology of the network is represented by M=(N, L, G), wherein N represents the node set, L represents the path set, and G=(P, Q) represents the region set, P represents the node set in the region; the node in the region is P, Q represents the path in the region, and the number of nodes in the network is |N|, the number of paths is |L|, and the number of nodes in the region is |P|; the path between nodes x and y is composed of a set of finite sequences r={n₀, n₁, . . . , nₙ}, and the effective path (x, y) between x and y has a length of |τ|;
packet reception rate is defined as:

$$R ( τ ) = \frac{{\sum }_{0 \leq i \leq \vert P \vert} \vert {p}_{i} \vert}{\vert P \vert} , p ∈ P , \vert {p}_{i} \vert = 1 \qquad ( 2.1 )$$

packet repetition rate is defined as:

$$M ( τ ) = \frac{{\sum }_{0 \leq i \leq \vert O \vert} \vert {n}_{i} \vert}{\vert O \vert} , n ∈ N , \vert {n}_{i} \vert = 1 \qquad ( 2.2 )$$

wherein n is the node that received duplicate packet, |O|=50;

### 2.2 Two Target Regions Algorithm

This section presents the theoretical details of the algorithm's flat routing and the details of LEFTR routing in the case of two target regions.

### 2.2.1 Two Target Regions Algorithm Theory

In this section, the LEFTR algorithm of the two target regions is described in detail on the plane, and FIG. 6 shows the detailed process. The source point and two target regions form a triangle. The calculation method of the Fermat point has been introduced in the previous section. The source point sends data to the Fermat point, and then the Fermat point forwards the data to two target regions. The transmission from the source point to the Fermat point and from the Fermat point to the two target regions adopts greedy forwarding, and the data is flooded in the target region.

### 2.2.2 LEFTR Algorithm for Two Target Regions

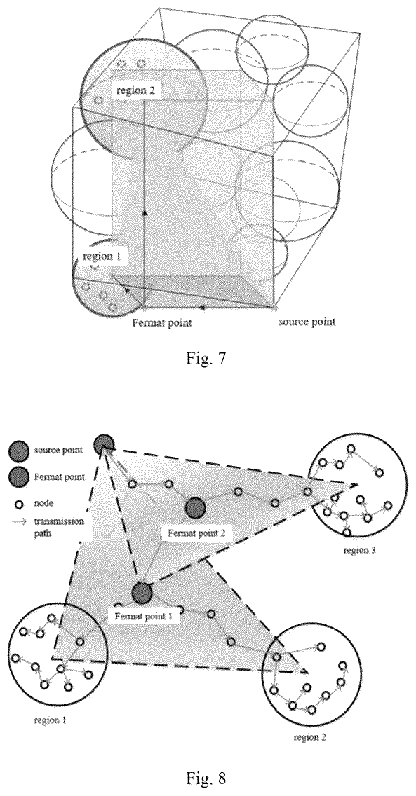

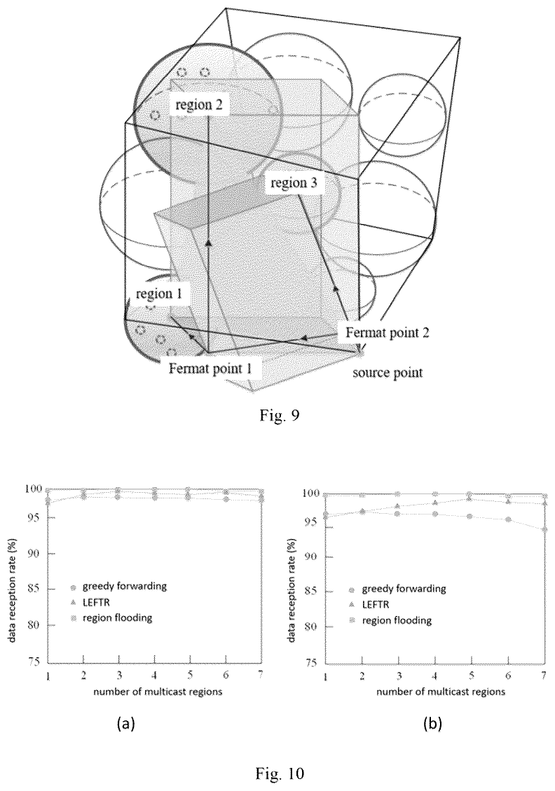

This section discusses how to compute Fermat point path when there are two target regions. In the entire 3D network, there are many regions, and there are many nodes in each region. As shown in FIG. 7, the invention uses a cube to represent the 3D network environment. The sphere inside the cube is the multicast region, and the dotted circle inside the sphere is satellite nodes.
S1: A triangle is formed by the source point, the center point (circle center) of region 1 and the center point of region 2, and the Fermat point position of this triangle is calculated;
S2: Use the node search algorithm to find a node that can be used as a Fermat point;
S3: The source node sends the data to the Fermat point node, and then the Fermat point node forwards the data to any node in the two regions respectively. The forwarding of these two parts uses greedy forwarding. When any point in the region receives the data, the flooding method is used to forward in this region, so that all nodes in the two regions can receive the data. So far, the regional multicasting of the two regions has been completed.

The above calculation and forwarding processes are all in a three-dimensional environment.

### 2.3 Multi-Target Regions Algorithm

This section presents the theoretical details of the algorithm's planar routing and the details of LEFTR routing in the case of multi-target regions.

### 2.3.1 Multi-Target Regions Algorithm Theory

This section will elaborate on the LEFTR algorithm for multi-target regions (three regions in FIG. 8) on the plane. The source point forms first triangle with region 1 and region 2, first Fermat point 1 is calculated, and Fermat point node selection algorithm is used to calculate first Fermat point node 1; then, the source point, the Fermat point 1 and region 3 form second triangle, second Fermat point 2 is calculated, and the Fermat point node selection algorithm is used to calculate second Fermat point node 2; the Fermat point 1 and the Fermat point 2 are connected to form Fermat point tree; if the source point wants to send data to three regions, the source point first send the data to Fermat point node 2 and then continue to send the data to Fermat point node 1, two Fermat points send the data to their corresponding regions; the transmission from the source point to the Fermat point and from the Fermat point to the region adopts greedy forwarding, and the data is flooded in the target region;

### 2.3.2 LEFTR Algorithm for Multi-Target Regions

In the actual application environment, there are often multi-target regions, so this section extends the LEFTR algorithm to multi-target regions, so as to realize efficient regional multicast in multi-target regions. A three-dimensional efficient transmission path is obtained by using the Fermat points, which is called a Fermat point tree; the cube represents three-dimensional network environment, the sphere represents the regional multicast region, virtual circle in the sphere represents satellite nodes, and region 1, region 2 and region 3 are three target regions respectively; regional multicasting in three regions is implemented. The pseudocode is shown in Table 2.1.
S1: Connect the source point, the center point of region 1 and the center point of region 2 to obtain a triangle, and calculate the Fermat point 1 of this triangle;
S2: Use the node search method to find a node suitable as a Fermat point, which is called the Fermat point node 1 (different from Fermat point);
S3: Connect the source point, Fermat point 1 and the center point of region 3 to form a second triangle, calculate the Fermat point of this triangle and get Fermat point 2;
S4: Also use the Fermat point search algorithm to find the Fermat point node 2;
S5: Connect the Fermat point node 1 and the Fermat point node 2. From the source point to the Fermat point node 1, and then to the Fermat point node 2, this path is the shortest path for regional multicast in region 1, region 2 and region 3.

TABLE 2.1
LEFTR Algorithm
Algorithm : LEFTR Algorithm

The source station is A, the Fermat point node set is F, and the center point set of

the region is N = {r₁, r₂, ... ..., rₙ}, |N| = n, n ≥ 3; the number of initialization
iterations is i = 3; B = r₁; C = r₂.

| 1) | loop | |
|---|---|---|
| 2) | | if i ≤ n; |
| 3) | | according to Algorithm 2, calculate the Fermat point fᵢ₋₂ of the triangle |

formed by A, B and C;

| | |
|---|---|
| 4) | according to Algorithm 1 and fᵢ₋₂, calculate the Fermat point node fnᵢ₋₂; |
| 5) | fnᵢ₋₂ → F; |
| 6) | set B = fnᵢ₋₂, C = rᵢ; |
| 7) | update the number of iterations i = i + 1; |

8)output the Fermat point node set F.

In particular, it should be noted that in the actual work process, the connected nodes are the Fermat point node 1 and the Fermat point node 2; the source node sends data to the Fermat point node 1 and then forwards it to the Fermat point node 2, where forwarding of this part uses greedy forwarding; the Fermat point node 1 greedily forwards the data to region 1 and region 2 after receiving the data, any node in region 1 and region 2 floods their region with the received data, the Fermat point node 2 also greedily forwards the data to region 3 after receiving the data, any node in region 3 floods its area after receiving the data; when there are more regions, the source point, the Fermat point and center point of region are connected, the Fermat point of the formed triangle is calculated, and then the Fermat points are concatenated into the Fermat point tree.

### 2.4 Simulation

### 2.4.1 Preparation

With the development and general application of satellite technology, an important way to expand the functions of satellites is to establish a network between satellites to make them work together. The traditional satellite networking method generally adopts the fixed time slot allocation method, which is not suitable for small satellite groups with short waiting time and high throughput requirements. In order to solve this problem, it has been proposed to apply the traditional Wi-Fi protocol in the satellite network.

### 2.4.2 Simulation Software NS-3

The simulation software used in this section is NS-3, the system is Linux, and the environment is Ubuntu. NS-3 is a scalable network simulation platform, it is not an upgrade of NS-2, but a brand new simulation software, which retains most of the functions of NS-2. NS-3 can easily implement most of the Internet protocols and algorithms, and can simulate a variety of networks, including wired networks and wireless networks. It has a complete library that can be used in combination, a graphical interface image, and tools for data tracking and analysis.

NS3 provides a certain degree of satellite network support which can simulate GEO and LEO satellites. The simulated content includes MAC protocol, data link, transmission protocol and routing protocol. Also, NS3 has extended the satellite network simulation in the following aspects: (1)Node definition: adding the object SatNode, which is used to define three kinds of nodes: geostationary satellite node, non-geosatationary satellite node and terminal node. There is a unified entry pointing to a series of address classifiers in the satellite node. The address classifier contains a table of slots for forwarding packets to external nodes. (2)Constellation definition: the position object is added, which is used to define satellite constellation parameters, including altitude, number of orbital planes, orbital inclination, inter-satellite link, satellite-ground link, ground elevation angle, etc. (3)Link definition: NS3 defines satellite links between inter-satellite and satellites-ground from two aspects. On the one hand, the node sets the network interface of the link through the add-interface process; on the other hand, the simulation program sets the channel of the inter-satellite link through add-isl, and sets the channel of the satellite-ground link through add-gsl.

Wherein three important systems are shown in Table 2.2:

TABLE 2.2
Comparison of Important Systems in NS-3

| System Name | Usefulness |
|---|---|
| Attribtue | configure the simulated network simulation objects and |
| System | the parameter values of the network simulation topology |
| Logging | set the output of the required network simulation |
| System | debugging information, which helps users understand the |
| | detailed execution process of the internal modules of |
| | the network |
| Tracing | structured output of simulation results in PCAP format |
| System | or ASCII format |

### 2.4.3 Simulation Environment and Indicators

### 2.4.3.1 Environment

The algorithm proposed in this section is based on the complex satellite network. It is now assumed that the future satellite environment will form a huge satellite network consisting of a large number of LEO satellites. It is assumed that the formed satellite network is relatively static in the space environment. Since the maximum inter-satellite distance for satellite inter-orbit communication reaches 3700 km, and the intra-orbit inter-satellite distance reaches 4500 km, even the distance may be involved under the huge satellite network in the future, the inter-satellite distance is relatively large. Assuming that the satellite is relatively stationary, the simulation experiment is carried out by using NS-3 and 802.11MAC protocols. First, a 2000*2000*2000 3D cube space is established, virtual coordinates are established, and a point of the cube is fixed at the origin coordinates to keep the 3D cube fixed. Because the deployment density of satellite nodes has a great influence on the routing algorithm, two scenarios are set up in this section: (1) randomly and densely deploy 500 nodes in the cube space; (2) randomly and non-densely deploy 200 nodes in the cube space. The fixedness and randomness of the nodes are kept, where the origin of the coordinate system is the data source point. For regional multicasting, seven regional multicasting regions are divided, and each multicasting region has at least 20 nodes on average. Different from the regional multicast in the two-dimensional environment, the multicast region in the three-dimensional environment is spherical. Each node has the same initial energy that the node is necrotic when the energy is exhausted.

It is stipulated that the total time of the network is 600 s, and the data packet is a fixed-size payload of 512 bytes. The energy of each node is set through the NS-3 energy model, the node is necrotic after 1000 forwarding times, and a data packet is sent every 5 ms.

### 2.4.3.2 Simulation Indicators

(1) Packet reception rate: the ratio of the number of members in the multicast region who received the data packets sent by the source point to the total number of members in the multicast region, as shown in formula (2.1). It can reflect the success rate of nodes receiving packets and the basic transmission performance of the algorithm.

(2) Packet repetition rate: randomly select 50 nodes except the multicast region for tracking, data packets are sent from the source point to the target region as shown in formula (2.2), the ratio of the nodes receiving duplicate data packets among the 50 nodes to all the nodes receiving data packets among the 50 nodes is the packet repetition rate of the nodes. When the packet repetition rate of nodes is too high, data redundancy occurs, which will increase the burden of network transmission and consume excessive energy.

(3) network collapse time: Set the energy of each node through the NS-3 energy model, and the initial value is set to 1000 forwarding times (node failure type is energy exhaustion failure). When the failure node accounts for 50% of the network summary points, the network connectivity drops significantly, which is considered that the network has collapsed, and the ability of the algorithm to prolong the life of the network is reflected.

### 2.4.3.3 Greedy Forwarding

The data packet is marked by the source node as the destination node or the location of the destination region to send the data packet. The location of each node's neighbor nodes is known, and the basis for selecting the next-hop node is the node whose geographical location is closest to the destination node, so that each forwarding will move closer to the target node until the target node is reached.

### 2.4.3.4 Region Flooding

The flooding method is a simple routing algorithm that the received packet is sent to all possible connection paths until the packet is reached. The flooding method is used to send data to all routers in the region, which does not require maintaining the network topology and related routing calculations. If the source node wants to send a piece of data to the target node, it first sends a copy of the data to all neighbor nodes, and then each node transmits the data to other nodes without the node that sent the data until the data is transmitted to the target node or the lifetime of the data reaches 0.

### 2.4.3.5 Peripheral Forwarding

Peripheral forwarding is a solution to the problem of routing holes in the greedy forwarding process, which use the right-hand rule to determine the next hop node.

### 2.4.4 Simulation Result Analysis

FIG. 10 shows the packet reception rate. The simulation is carried out 7 times in the two scenarios, and the number of regions simulated each time is increased by 1.

### Experiment 1:

As shown in FIG. 10(a), the figure shows the packet reception rate under dense coverage of 500 nodes. The data transmission efficiency of the LEFTR algorithm is close to the region flooding algorithm. As shown in FIG. 10(b), the figure shows the packet reception rate under non-dense coverage of 200 nodes. At this time, the data transmission rate of the greedy forwarding algorithm is overall lower than that of 500 nodes. When sending data packets to all 7 regions, the packet reception rate drops to 93%. In a dense network, greedy forwarding has good performance and high efficiency, but in a non-dense network, greedy forwarding may cause routing “empty holes” problem. Therefore, in FIG. 10(b), the data reception rate of the greedy forwarding algorithm drops relative to that of FIG. 10(a). This is because from the perspective of the algorithm itself, the Fermat point acts as an “intermediate station”, as a relay from the source point to the target region, which shortens the overall transmission distance and effectively avoids the chance of greedy forwarding errors in long-distance forwarding. At the same time, the LEFTR algorithm adds peripheral forwarding to bypass routing empty holes problem. Specifically, when encountering routing holes problem, switch the greedy forwarding mode to peripheral forwarding, and judge the next jump node according to the “right-hand rule”: connect the current node and the destination node to form a straight line, hold the line with right hand and rotate it counterclockwise. The first edge you arrive at (the edge means that the two points on it can reach each other) is the direction of the next hop, thus bypassing the routing hole.

Because of the principle of flooding to all one-hop neighbors (except the neighbor that sends data), the data reception rate can reach almost 100%, and it still performs well in a three-dimensional environment. Although the data reception rate of LEFTR is not as good as the data reception rate of the flooding method, but the data reception rate of LEFTR is higher than the data reception rate of greedy forwarding, which is an ideal data transmission rate, but this is not the focus of LEFTR. LEFTR mainly achieves the purpose of reducing transmission energy consumption by shortening the transmission path. It performs well in terms of energy saving, and its overall performance is better than that of flooding and greedy forwarding.

### Experiment 2:

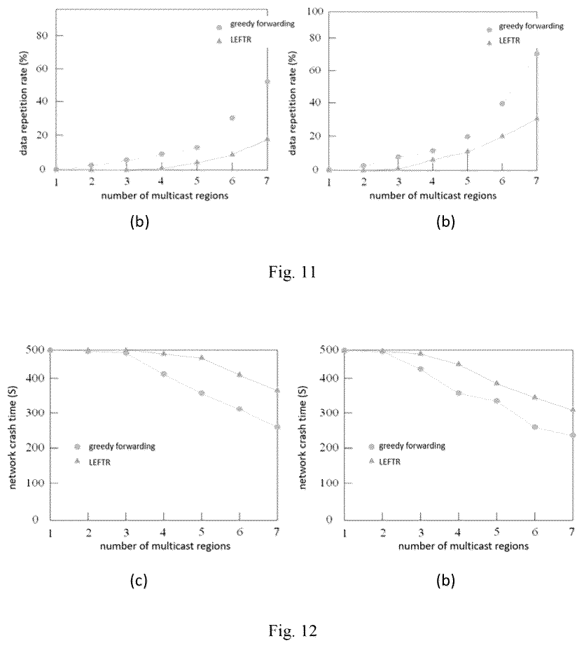

The network is more effective in a three-dimensional environment, that is, each node communicates with its neighbor nodes in hello packets, so that each satellite node can obtain the location information of neighbor nodes within its own communication radius and provide a basic information for selecting the next hop. The greedy forwarding algorithm has low computational complexity and simple principle, and the generated routing path is close to the ideal optimal shortest path. It is one of the most popular algorithms in the three-dimensional environment. Therefore, the greedy forwarding algorithm is selected for comparative experiments. FIG. 11 shows the packet repetition rate. As shown in FIG. 11(a), the information describes the repetition rate of the nodes which receive the data packet under the non-dense coverage of 200 nodes. It can be seen that when there is one regional multicast region, the repetition rate is 0.2%. With the increase of number of the multicast region, the repetition rate rises faster. At 7 regions, this has been increased to 50%. As shown in FIG. 11(b), it shows the repetition rate of data packets received by nodes under the dense coverage of 500 nodes. In 7 regions, the repetition rate of packets received by the nodes of the greedy forwarding algorithm is as high as 70%. This is because when there is only a single region, the source node only needs to send one data to one region, and the transmission path of this data is close to the ideal shortest path. But when the number of the regions gradually increases, the source node needs to send more data to find the shortest path to the corresponding multicast region. At this time, the data will be redundant, which increases the network overhead. For the Fermat point tree formed by the LEFTR algorithm, even if the number of the multicast regions increases, the source node only needs to send data once. This data is delivered to each multicast region through the Fermat point tree. The result shows that under the dense coverage of 500 nodes, when sending data to 7 multicast regions, the repetition rate is 30%. Therefore, LEFTR greatly reduces the network overhead during regional multicasting, and the network has strong robustness.

For greedy forwarding, the amount of data sent will increase as the number of target regions increases, and the source point of each target region needs to send data once in a targeted manner, so there is a problem of data redundancy. For LEFTR, the data is transmitted through the Fermat point tree. No matter how many target regions are targeted, the source point only needs to send data once, which avoids data redundancy to a large extent, so the data packet repetition rate is lower than greedy forwarding.

### Experiment 3:

The total time of the network is 600 s. The energy of each node is set through the NS-3 energy model. The initial value is set to 1000 times of forwarding (node failure type is energy exhaustion failure). When the failure node accounts for 50% of the nodes of the entire network, the degree of network connectivity drops sharply, and the network is considered to have collapsed at this time. A packet is sent every 5 ms and the time is watched when the network crashes.

FIG. 12 shows the network crash time. As shown in FIG. 12(a), the network crash time records under non-dense coverage of 200 nodes. As shown in FIG. 12(b), the network crash time records under the dense coverage of 500 nodes.

It can be seen from the figure that no matter in dense network or non-dense network, LEFTR algorithm makes full use of the energy of nodes compared with the greedy forwarding algorithm with better performance in three-dimensional environment. This section defines that a node will die if it is forwarded 1000 times. When the number of the multicast regions of the greedy forwarding algorithm increases, the network crashes faster, while the LEFTR algorithm can gently reduce the crash time.

This is because the characteristics of Fermat point are used to reduce the path of data transmission, mainly to reduce the number of intermediate hops, and the Fermat point tree composed of each Fermat point controls the amount of data sent by the source point to the minimum. Data redundancy is reduced, which also reduces the energy consumption of each node processing data to a certain extent, thereby balancing the energy consumption of node in the entire network. Therefore, the proposed LEFTR algorithm can greatly improve the survival time of the network.

### 2.5 Summary

This invention first introduces the LEFTR algorithm for two target regions and multi-target regions from the theoretical aspect, and then gives the LEFTR algorithm and detailed steps for two target regions and multi-target regions in a real complex network environment. The characteristics of Fermat points are used to find a shortest path from the source point to the target region, that is, the application of the Fermat point tree can reduce the number of path hops and verify the effectiveness of the algorithm from packet reception rate, packet repetition rate and network crash time. Simulation results show that this algorithm can effectively save and balance transmission energy consumption and prolong network life.

The above descriptions are only examples of the invention, and are not used to limit the protection scope of the invention. For those skilled in the art, the application can have various modifications and changes. Any modification, equivalent replacement, improvement, etc. made within the spirit and principle of this invention shall be included in the protection scope of this invention.

1. A low-energy-consumption routing method based on inter-satellite communication, wherein the method includes calculating of improved three-dimensional Fermat points, calculating of Fermat points of three target regions, selecting of satellite nodes of Fermat points and low-energy-consumption Fermat point three-dimensional routing algorithm LEFTR;
the calculating of improved three-dimensional Fermat points is:
set side length of cube as x;
Condition 1: in the cube, points A and B are two vertices of the cube, line AB is diagonal of the cube, and C is any point in the cube that is different from points A and B; at this time, point C is Fermat point F;
$$F A + F B + F C = F A + F B = 2 \sqrt{{x}^{2} + {( \frac{1}{2} x )}^{2}} = \sqrt{5} x \qquad ( 1.1 )$$
when the points A and B are two vertices of the cube, line AB is diagonal of the cube, C is any point in the cube that is different from the points A and B, and FA+FB+FC is the shortest, point C is the Fermat point;
Condition 2: in the cube, points A, B, and C are three vertices of the cube, and sides AB, BC, and CA are diagonals of faces; at this time, Fermat point F is the center point of the cube;
$$F A + F B + F C = 3 \sqrt{{( \frac{1}{2} x )}^{2} + {( \sqrt{{( \frac{1}{2} x )}^{2} + {( \frac{1}{2} x )}^{2}} )}^{2}} ≦ 3 x ⇒ \frac{9}{4} x ≦ 3 x \qquad ( 1.2 )$$
wherein 3x is the value of FA+FB+FC when the Fermat point is the vertex P of the cube corresponding to ΔABC; when the points A, B, and C are three vertices of the cube, sides AB, BC, and CA are diagonals of faces, and FA+FB+FC is the shortest, the Fermat point is the center point of the cube;
Condition 3: in the cube, points A and B are two vertices of the cube, AB is a side of the cube, point C is a point on the opposite side parallel to side AB; at this time, Fermat point F is the center point of the cube;
$$F A + F B + FC = 2 \sqrt{{( \frac{1}{2} x )}^{2} + {( \sqrt{{( \frac{1}{2} x )}^{2} + {( \frac{1}{2} x )}^{2}} )}^{2}} + \frac{1}{2} \sqrt{{x}^{2} + ( \sqrt{{x}^{2} + {x}^{2}} )} ≦ x + \sqrt{2} x ⇒ \{ \frac{1}{2} \sqrt{\frac{1}{4} {x}^{2} + \frac{1}{2} {x}^{2}} + \frac{1}{2} \sqrt{3 {x}^{2}} ≦ x + 2 x ⇒ \frac{3 \sqrt{3}}{2} x ≦ ( 1 + \sqrt{2} ) x \qquad ( 1.3 )$$
wherein x+\sqrt{2x} is the value of FA+FB+FC when taking point P from the Fermat point; point P is the vertex of the cube corresponding to ΔABC; in the proof, distance from the vertex of the cube to the center point is taken and the distance from any other point on the opposite side to the center point is smaller than this distance; when the points A and B are two vertices of the cube, AB is a side of the cube, point C is the point on the opposite side parallel to side AB, the Fermat point is the center point of the cube.

2. (canceled)

3. The low-energy-consumption routing method based on inter-satellite communication according to claim 1, wherein the calculating of Fermat points of three target regions is:
set side length of cube as x;
Condition 1: in the cube, points A and B are two vertices of the cube, line AB is diagonal of the cube, wherein point D is divided into two cases; in the two cases, the points D is divided into D₁ and D₂ respectively;
when line connections of the four points A, B, C and D intersects, as D₁ shown in figure, Fermat point is taken as the intersection point F₁, and the proof is as follows:
$${F}_{1} A + {F}_{1} B + {F}_{1} C = \sqrt{{x}^{2} + {( \sqrt{{x}^{2} + {x}^{2}} )}^{2}} + \sqrt{{( \frac{1}{2} x )}^{2} + ( \sqrt{{x}^{2} + {( \frac{1}{2} x )}^{2}} )} = \frac{3 \sqrt{3}}{2} x \leq \sqrt{{x}^{2} + {( \sqrt{{x}^{2} + {x}^{2}} )}^{2}} + \frac{\sqrt{{x}^{2} + {x}^{2}}}{2} + \frac{\sqrt{{x}^{2} + {x}^{2}}}{2} = ( \sqrt{2} + \sqrt{3} ) x \qquad ( 1.4 )$$
wherein (\sqrt{2}+\sqrt{3})x is the length of FA+FB+FC when the Fermat point is taken as the center point of the cube; when there is an intersection point between the four points A, B, C and D, and the Fermat point as the intersection point F₁ is taken to have the shortest length of FA+FB+FC, the Fermat point is taken as the intersection point F₁; point C is the point on the opposite side parallel to side AB; when line connections of the four points A, B, C and D don't intersects, Fermat point is taken as the center point of the cube, and the proof is as follows:
$${F}_{2} A + {F}_{2} B + {F}_{2} C = \sqrt{{x}^{2} + {x}^{2}} + \sqrt{{x}^{2} + {( \sqrt{{x}^{2} + {x}^{2}} )}^{2}} = ( \sqrt{2} + \sqrt{3} ) x \leq x + 2 \sqrt{{( \frac{1}{2} x )}^{2} + {x}^{2}} = ( 1 + \sqrt{5} ) x \qquad ( 1.5 )$$
wherein (1+\sqrt{5})x is the length of FA+FB+FC when the Fermat point is taken as point D₂. When the line connections of the four points A, B, C and D don't intersects, and the Fermat point as the center point of the cube is taken to have the shortest length of FA+FB+FC, the Fermat point is taken as the center point of the cube;
Condition 2: in a cube, lines AB, BC, and CA are diagonals of faces, wherein point D is divided into two cases; in the two cases, the point D is divided into D₁ and D₂ respectively; under this condition, the line connections of the four points A, B, C and D don't intersects, D₁ is located above ΔABC, and D₂ is located below ΔABC; (1) when point D is located above ΔABC, the Fermat point is taken as the center point of the cube, and the proof is as follows:
$${F}_{1} A + {F}_{1} B + {F}_{1} C = 2 \sqrt{{x}^{2} + {( \sqrt{{x}^{2} + {x}^{2}} )}^{2}} = 2 \sqrt{3} x \leq 3 \sqrt{{x}^{2} + {x}^{2}} = 3 \sqrt{2} x \qquad ( 1.6 )$$
wherein 3\sqrt{2x} is the length of FA+FB+FC when the Fermat point is taken as D₁; when D is located above ΔABC, and the Fermat point as the center point of the cube is taken to have the shortest length of FA+FB+FC, the Fermat point is taken as the center point of the cube;
(2) when point D is located below ΔABC, the Fermat point is taken as D₂, and the proof is as follows:
$${F}_{2} A + {F}_{2} B + {F}_{2} C = x + x + x = 3 x \leq 2 \sqrt{{x}^{2} + {( \sqrt{{x}^{2} + {x}^{2}} )}^{2}} = 2 \sqrt{3} x \qquad ( 1.7 )$$
wherein 3\sqrt{2x} is the length of FA+FB+FC when the Fermat point is taken as the center point of the cube. When D is located below ΔABC, and the Fermat point as the point D₂ is taken to have the shortest length of FA+FB+FC, the Fermat point is taken as the point D₂;
Condition 3: in a cube, line AB is a side of the cube, and point D is divided into two cases. In the two cases, the point D is divided into D₁ and D₂ respectively; there is an intersection point at the position A, B, C and D of D₁, but there is no intersection point at the position A, B, C and D of D₂;
when line connections of the four points A, B, C and D intersects, Fermat point is taken as intersection point F₁, and the proof is as follows:
$${F}_{1} A + {F}_{1} B + {F}_{1} C = 2 \sqrt{{x}^{2} + {( \sqrt{{{x}^{2} ( \frac{1}{2} x )}^{2}} )}^{2}} = 3 x \leq \frac{1}{2} \sqrt{{x}^{2} + {x}^{2}} \times 2 + \frac{1}{2} \sqrt{{x}^{2} + {( \sqrt{{x}^{2} + {x}^{2}} )}^{2}} \times 2 = ( \sqrt{2} + \sqrt{3} ) x \qquad ( 1.8 )$$
wherein (\sqrt{2}+\sqrt{3})x is the length of FA+FB+FC when the Fermat point is taken as the center point of the cube; when the line connections of the four points A, B, C and D intersects, and the Fermat point as the center point of the cube is taken to have the shortest length of FA+FB+FC, the Fermat point is taken as the center point of the cube; when line connections of the four points A, B, C and D don't intersects, Fermat point is taken as the center point of the cube, and the proof is as follows:
$${F}_{2} A + {F}_{2} B + {F}_{2} C = \sqrt{{x}^{2} + {x}^{2}} + \sqrt{{x}^{2} + {( \sqrt{{x}^{2} + {x}^{2}} )}^{2}} = ( \sqrt{2} + \sqrt{3} ) x \leq \sqrt{{( \frac{1}{2} x )}^{2} + {( \frac{1}{2} x )}^{2}} + \sqrt{{x}^{2} + {( \frac{1}{2} x )}^{2}} + \sqrt{{x}^{2} + {( \sqrt{{{x}^{2} ( \frac{1}{2} x )}^{2}} )}^{2}} = \frac{\sqrt{2} + \sqrt{5} + 3}{2} x \qquad ( 1.9 )$$
wherein
$$\frac{\sqrt{2} + \sqrt{5} + 3}{2} x$$
is the length of FA+FB+FC when the Fermat point is taken as point D₂; when the line connections of the four points A, B, C and D don't intersects, and the Fermat point as the center point of the cube is taken to have the shortest length of FA+FB+FC, the Fermat point is taken as the center point of the cube.

4. The low-energy-consumption routing method based on inter-satellite communication according to claim 3, wherein the selecting of satellite nodes of Fermat points is:
satellite node i has two important parameters: remaining energy Eᵢ and the distance D_{if} to the Fermat point; distance between the node and the Fermat point is considered to avoid excessive energy consumption of a certain node; when remaining energy of sensor node is lower than threshold T, the Fermat point node is changed, and the threshold T takes 30% of total energy of the node; after calculating the position of the Fermat point, the position of the Fermat point is taken as the center of the circle to search outward, wherein the search range is a sphere, and the radius r starts from 0 and increments by 1 km; if there is a node in first search range, the closest node to the Fermat point is selected, otherwise search continues;
if there are nodes with same distance in same search range, one of them is randomly selected; if energy of the selected node is less than the threshold, search continues.

5. The low-energy-consumption routing method based on inter-satellite communication according to claim 4, wherein the low-energy-consumption Fermat point three-dimensional routing algorithm LEFTR is:
S21: related definitions and symbols;
the physical topology of the network is represented by M=(N, L, G), wherein N represents the node set, L represents the path set, and G=(P, Q) represents the region set, P represents the node set in the region; the node in the region is P, Q represents the path in the region, and the number of nodes in the network is |N|, the number of paths is |L|, and the number of nodes in the region is |P|; the path between nodes x and y is composed of a set of finite sequences τ={n₀, n₁, . . . , nₙ}, and the effective path (x, y) between x and y has a length of |τ|;
packet reception rate is defined as:
$$R ( τ ) = \frac{{\sum }_{0 \leq i \leq \vert P \vert} \vert {p}_{i} \vert}{\vert P \vert} , p ∈ P , \vert {p}_{i} \vert = 1 \qquad ( 2.1 )$$
packet repetition rate is defined as:
$$M ( τ ) = \frac{{\sum }_{0 \leq i \leq \vert O \vert} \vert {n}_{i} \vert}{\vert O \vert} , n ∈ N , \vert {n}_{i} \vert = 1 \qquad ( 2.2 )$$
wherein n is the node that received duplicate packet, |O|=50;
S2: two target regions algorithm;
source point sends data to the Fermat point, and then the Fermat point forwards the data to two target regions; the transmission from the source point to the Fermat point and from the Fermat point to the two target regions adopts greedy forwarding, and the data is flooded in the target region; the two target regions are region 1 and region 2;
S21: a triangle is formed by the source point, center point of region 1 and center point of region 2, and position of the Fermat point of this triangle is calculated;
S22: node search algorithm is applied to find node which can be used as Fermat point;
S23: the source node sends the data to the Fermat point node, and then the Fermat point node forwards the data to any node in the two regions; the forwarding of these two parts adopts greedy forwarding; when any point in the region receives the data, flooding method is used in this region to forward the data, so that all nodes in the two regions can receive the data to complete the regional multicast in the two regions;
S3: multi-target regions algorithm
S31: multi-target regions algorithm;
the source point forms first triangle with region 1 and region 2, first Fermat point 1 is calculated, and Fermat point node selection algorithm is used to calculate first Fermat point node 1; then, the source point, the Fermat point 1 and region 3 form second triangle, second Fermat point 2 is calculated, and the Fermat point node selection algorithm is used to calculate second Fermat point node 2; the Fermat point 1 and the Fermat point 2 are connected to form Fermat point tree; if the source point wants to send data to three regions, the source point first send the data to Fermat point node 2 and then continue to send the data to Fermat point node 1, two Fermat points send the data to their corresponding regions; the transmission from the source point to the Fermat point and from the Fermat point to the region adopts greedy forwarding, and the data is flooded in the target region;
S32: LEFTR algorithm for multiple target regions;
a three-dimensional efficient transmission path is obtained by using the Fermat points, which is called a Fermat point tree; the cube represents three-dimensional network environment, the sphere represents the regional multicast region, virtual circle in the sphere represents satellite nodes, and region 1, region 2 and region 3 are three target regions respectively; regional multicasting in three regions is implemented;
S321: the source point, the center point of region 1 and the center point of region 2 are connected to obtain a triangle, and the Fermat point 1 of this triangle is calculated;
S322: the node search method is used to find a suitable node as a Fermat point which is called Fermat point node 1;
S323: the source point, the Fermat point 1 and the center point of region 3 are connected to form a second triangle, the Fermat point of this triangle is calculated, and the Fermat point 2 is obtained;
S324: the node search method is used to find a suitable node as a Fermat point which is called Fermat point node 2;
S32: the Fermat point node 1 and the Fermat point node 2 are connected; the path from the source point to the Fermat point node 1 and then to the Fermat point node 2 is the shortest path for regional multicast in region 1, region 2 and region 3;
the connected nodes are the Fermat point node 1 and the Fermat point node 2; the source node sends data to the Fermat point node 1 and then forwards it to the Fermat point node 2, where forwarding of this part uses greedy forwarding; the Fermat point node 1 greedily forwards the data to region 1 and region 2 after receiving the data, any node in region 1 and region 2 floods their region with the received data, the Fermat point node 2 also greedily forwards the data to region 3 after receiving the data, any node in region 3 floods its area after receiving the data; when there are more regions, the source point, the Fermat point and center point of region are connected, the Fermat point of the formed triangle is calculated, and then the Fermat points are concatenated into the Fermat point tree.
